(19) United States
(12) Patent Application Publication
(10) Pub. No.: US 2006/0291048 A1
(43) Pub. Date: Dec. 28, 2006

(54) Multi-axis imaging system with single-axis relay

(75) Inventors: Artur G. Olszak, Tucson, AZ (US); Michael R. Descour, Tucson, AZ (US)

Correspondence Address: ANTONIO R. DURANDO, 6902 N. TABLE MOUNTAIN ROAD, TUCSON, AZ, 85718-1331, US

(73) Assignee: DMetrix, Inc., Tucson, AZ (US)

(21) Appl. No.: 11/511,720

(22) Filed: Aug. 29, 2006

Related U.S. Application Data
(63) Continuation-in-part of application No. 10/690,878, filed on Oct. 22, 2003.
(63) Continuation-in-part of application No. 10/637,486, filed on Aug. 11, 2003.
Application No. 10/637,486 is a continuation of application No. PCT/US02/08286, filed on Mar. 19, 2002.
(60) Provisional application No. 60/276,498, filed on Mar. 19, 2001.

(51) Int. Cl. G02B 23/24

(52) U.S. Cl. 359/434

(57) ABSTRACT

A single-axis optical system is introduced in the imaging channel of an array microscope in order to relay the image of the sample object onto a detector placed apart from the array. Because of the relatively large size of the single-axis system, sufficient space is available to provide simultaneous epi-illumination to all objectives in the array with a single lateral source directed toward the sample object by a beam splitter positioned along the imaging train. As a result of this configuration, conjugate aperture-stop positions are provided that can be used to place optical elements in the system to affect the properties of the illumination and/or the imaging wavefronts.

### RELATED APPLICATIONS

This application is a continuation-in-part application of U.S. Ser. No. 10/690,878, filed Oct. 22, 2003, and a continuation-in-part application of U.S. Ser. No. 10/637,486, filed Aug. 11, 2003, which is based on PCT/US02/08286, filed Mar. 19, 2002, and claims the benefit of priority of U.S. Provisional Application No. 60/276,498, filed Mar. 19, 2001, under 35 U.S.C. Sect. 119.

### BACKGROUND OF THE INVENTION

1. Field of the Invention

This invention relates in general to the field of microscopy and, in particular, to a novel approach for providing epi-illumination to an array microscope.

2. Description of the Prior Art

As described in various embodiments in co-owned International Application PCT/US02/08286 and U.S. Patent Application Ser. No. No. 10/158,626, herein incorporated by reference, array microscopes comprise a plurality of optical imaging elements configured to image respective sections of an object and disposed with respect to an object plane so as to produce at respective image planes respective images of the respective sections of the object measurements. The object may be illuminated in a variety of ways. Depending on the direction of object illumination, the term trans-illumination is used in the art to refer to systems where the light collected by the observation system passes through the sample, while the term epi-illumination is used when the object is illuminated from the same side of the observation system. Epi-illumination is used for opaque samples or when it is disadvantageous to receive the illumination beam directly, such as in fluorescence imaging, known as epi-fluorescence. This invention concerns epi-illumination and related microscopic techniques applied to array microscopes.

Adequate illumination of the object plays an important role in microscopy. Several important imaging parameters, such as optical resolution and contrast, depend on the optical system's numerical aperture, the illumination's temporal and spatial coherence, polarization, distribution of irradiance, and intensity. Except for special cases, optical systems are designed to provide a uniform irradiance of the object and to completely fill the numerical aperture of the observation channel.

Typically epi-illumination systems are implemented by inserting a beam splitter in the imaging train, such that the illumination and the imaging systems share part of the optical train. FIG. 1 is an example of such a configuration, known as Koehler illumination, wherein the light source is imaged into the imaging system pupil. The epi-illumination microscope 10 consists of a light source 12, such as a light bulb, positioned along a lateral axis 14 to illuminate an object 16 on reflection from a beam splitter 18. The imaging channel consists of an infinity corrected objective 20, an aperture stop 22, and a tube lens 24. The light from the source 12 is passed through a condenser 26 and reflected in part by the beam splitter 18 toward the object 16. The light scattered and reflected by the object returns through the beam splitter towards a detector 28 located on the optical axis 30 of the imaging lens.

Another type of illumination that is sometimes used in epi-illumination microscopy is the so-called critical illumination configuration, where the light source is imaged at the object plane. This provides a shorter illumination system, but requires that the light source provide uniform radiance. Like in the case of Koehler illumination, the light source is ordinarily disposed actually or virtually on the optical axis of the imaging lens.

The use of beam splitters to achieve epi-illumination works well with conventional microscopy systems, but it is much more difficult to implement in an array microscope where all components are arranged very tightly in a very small space, as illustrated in FIG. 2. Such an array microscope 32 consists of a number of lens plates 34, each patterned with individual lenses 36 disposed in staggered rows which, coupled to other correspondingly staggered rows of lenses in parallel plates, form individual optical systems 38. As illustrated by arrow S in FIG. 2, the array microscope 32 is translated along a linear direction of motion with respect to the object 40 (or vice versa). The rows of lenses in the array microscope are staggered with respect to the direction of scan and image frames are acquired during the scan across the object, such that each of the optical systems 38 acquires images corresponding to a respective continuous strip of the object along the direction of scan. Because of the staggered arrangement of the rows of lenses, the continuous strip covered by the linear scan of each optical system 38 is substantially free of overlap with continuous strips covered by other optical systems. Thus, at each acquisition frame each system 38 projects the image of a small section of the sample object 40 directly onto a detector 42 and the individual images are then combined to form a composite image of the entire object by hardware or software manipulation. The details of implementation of array microscopes are disclosed in copending PCT/US02/08286U.

The use of array microscopes is based on the realization that small optical systems can provide good-quality, high-resolution imaging with magnification. Accordingly, each individual optical system in the array is designed to perform such a function and a plurality of systems is packed together as closely as possible within the constraints of the physical size of each component. A typical individual microscope system used in an array microscope is shown in FIG. 3 and includes a set of lenses (generically referenced as lenses 36 in FIG. 2) specifically designed for a particular type of application. As illustrated, because of the magnification of the system and the need to avoid imaging overlaps on the detector 42, only a small field of view 50 can be captured at the detector plane within the area corresponding to each microscope system. In order to avoid overlaps, the detector 42 cannot be separated from the set of lenses 36 more than allowed by the system's magnification. Therefore, the lenses are necessarily packed very tightly in both lateral and axial directions, leaving very little space for other optical components such as beam splitters. This renders the conventional beam-splitter approach for implementing epi-illumination inconvenient at best and, in many cases, actually impossible to realize in an array microscope.

Co-owned U.S. Ser. No. 10/158,626 discloses a number of solutions for successfully implementing epi-illumination in array microscopes. However, those solutions require the use of advanced manufacturing technologies that are still difficult to implement economically and reliably. Therefore, there is still a need for a more practical approach to epi-illumination of array microscopes. This invention provides a variety of solutions that combine the imaging advantages of array microscopy with the simplicity of single optical-axis epi-illumination.

### SUMMARY OF THE INVENTION

In essence, the invention consists of introducing a single-axis optical system in the imaging channel of the array microscope in order to relay the image of the sample object onto a detector placed at a greater distance from the object plane than in conventional array microscopy. Because of the relatively large size of single-axis optical systems in relation to the size of array microscopes, sufficient space is available in the single-axis train to provide simultaneous illumination to all multi-axis objectives in the array using a single lateral light source and a beam splitter in the imaging train reflecting the light toward the sample object. Thus, according to the main aspect of the invention, epi-illumination is provided simply and efficiently to the array microscope.

According to another aspect, the invention provides conjugate aperture-stop positions that may be used to place optical elements in the system to affect the properties of the illumination and/or the imaging wavefronts. For example, sets of complementary plates could be inserted in the system to carry out phase-contrast techniques and/or Hoffman modulation-contrast techniques; cubic phase plates to increase the depth of focus; differential-interference-contrast elements, or polarizing elements as needed for practicing DIC or Nomarsky techniques; targeted obscurations of the pupil to manipulate the spatial coherence of the illumination and/or imaging optics; and phase plates to manipulate aberration and focusing properties of individual optical systems.

According to another aspect of the invention, the relay system is used also to correct residual aberrations introduced by the microscope array objectives. Since the relay optics may be made of conventional optical glass, which offers a larger range of optical properties (such as index of refraction and dispersion number) than the materials used to form the optical elements of array microscopes, the relay optics may be modified by conventional design to correct array imperfections such as chromatic aberrations. Similarly, if imaging at different wavelengths requires compensation due to the relative movement of the detector, the relay system can be used to provide such additional compensation simply as a matter of design of the array microscope.

According to yet another aspect of the invention, the epi-illumination array microscope is combined with an additional light source positioned on the opposite side of the sample to also provide trans-illumination. Therefore, the microscope can be used alternatively or simultaneously with epi- and trans-illumination modalities, for example in epi-fluorescence and dark-field trans-illumination modes, as well as in epi-illumination.

Various other advantages will become clear from the description of the invention in the specification that follows and from the novel features particularly pointed out in the appended claims. Therefore, to the accomplishment of the objectives described above, this invention consists of the features hereinafter illustrated in the drawings, fully described in the detailed description of the preferred embodiments, and particularly pointed out in the claims. However, such drawings and descriptions disclose only some of the various ways in which the invention may be practiced.

### BRIEF DESCRIPTION OF THE DRAWINGS

FIG. 1 is a schematic component and ray-trace illustration of a conventional epi-illumination microscope.

FIG. 2 is a schematic perspective view of a typical array microscope composed of a number of lens plates.

FIG. 3 illustrates the four-lens optical system of an individual miniature microscope with numerical aperture of 0.75 and the corresponding ray trace.

FIG. 4 is a view of the array microscope of FIG. 2 combined with a single-axis relay system to project all array images from the original detector plane to a new, further removed detector plane according to the present invention.

FIG. 5 is a schematic representation and illustrates the ray trace of an epi-illumination array microscope according to the invention wherein the single-axis relay system is used to provide illumination to the array.

FIG. 6 is a schematic representation and illustrates the ray trace of an epi-illumination array microscope according to the invention with additional polarizing elements to materially improve the light efficiency of the system.

FIG. 7 is a schematic representation and illustrates the ray trace of an epi-illumination array microscope according to the invention wherein the beam splitter is offset with respect to the pupil position in order to provide two separate planes in the illumination and imaging systems conjugate with the aperture stop of the array.

FIG. 8 illustrates the access to the pupil location provided by the single-axis relay system of the invention, including an example of a generic plate inserted to modify the illumination wavefront.

FIG. 9A illustrates two typical aperture/phase-contrast plates that can be used, upon placement across the illumination and imaging beams of the device of the invention, to change the character of the illumination and imaging beams.

FIG. 9B illustrates two typical Hoffman modulation-contrast plates that can be used, upon placement across the illumination and imaging beams of the device of the invention, to practice Hoffman microscopy.

FIG. 9C is a spot diagram for an array microscope system without relay and refocusing. The RMS radius is on the order of 29 μm.

FIG. 9D is an MTF plot for the system of FIG. 9C without relay, illustrating poor performance.

FIG. 9E is the spot diagram for the same array microscope system with relay optics (no refocusing). The RMS radius size improved to about 8 μm.

FIG. 9F is the MTF plot for the same system with relay optics, illustrating a significant improvement in image quality (especially on axis).

FIG. 10 illustrates a system wherein an additional light source is used to provide dual epi-illumination and trans-fluorescence illumination.

FIG. 11 illustrates an array microscope wherein the single-axis relay system is placed between two multiple-axis systems in sequence.

FIG. 12 illustrates an array microscope wherein the optical relay system is used to provide side detection in epi-illumination.

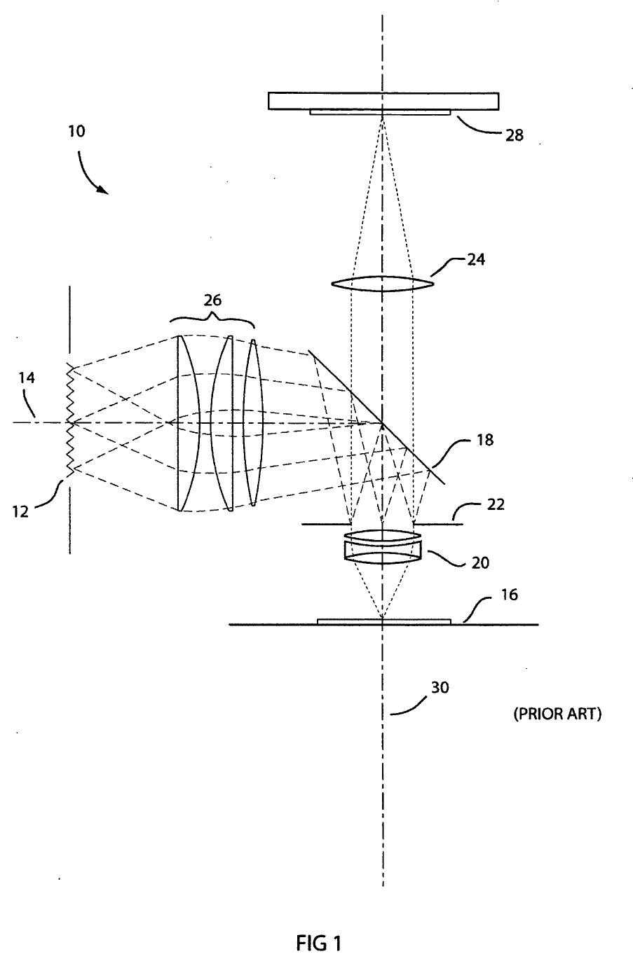

### DETAILED DESCRIPTION OF THE INVENTION

The main inventive concept of this disclosure resides in the idea of interposing a single-axis relay system in the imaging train of a multiple-axis imaging system. Through the relay system, it is possible to provide epi-illumination as well as various forms of operating modalities heretofore not possible with multiple-axis imaging systems such as array microscopes.

As used in this disclosure, the terms “stop” and “aperture stop” refer to the aperture stop associated with the array microscope. The term is used both with respect to the aperture stop of each microscope in the array, as determined by the optics constituting each optical system, and with respect to the aperture stop of the entire array (which is a composite of all individual systems). With reference to the scanning direction of the imaging system of the invention, as claimed, the term “linear” is intended to cover a straight as well as a curvilinear path during which each objective of the microscope array acquires image data (light intensity) corresponding to a respective straight or curvilinear continuous strip of the object. Finally, relay system” is intended to refer to any optical system that relays an image of an object, whether real or virtual, from a first plane onto a second plane, which may be coextensive with the first plane, including planes located at infinity.

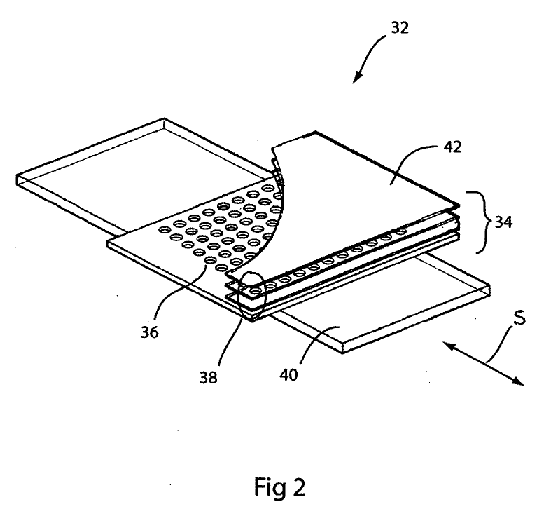

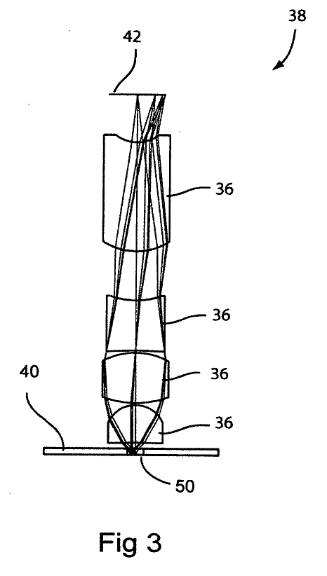

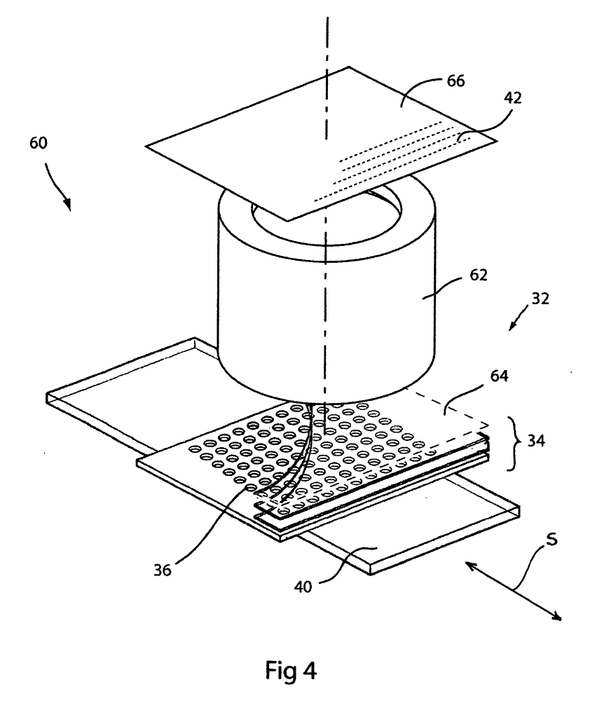

Referring to the figures, wherein like parts are referred throughout with like reference numerals and symbols, FIG. 4 illustrates an epi-illumination microscope system 60 according to the invention. The basic configuration of the device consists of an array microscope 32 (as shown in FIG. 2) combined with a single-axis optical relay system 62 positioned between the lens plates 34 and the detector 42 of the array. The rows of lenses 36 are staggered in each plate with respect to the linear direction of scan (illustrated by the arrow S in the figure), so that each optical system 38 acquires image data corresponding to a strip of the object 40 during the continuous, linear, relative translation of the array microscope 32 and the object 40. The function of the relay optics is to simultaneously relay all images formed by the multiple imaging systems 38 of the array onto another plane. At the same time, the system provides enough space to implement conventional epi-illumination for the array microscope.

The array microscope 60 images the object 40 onto the image plane 64 (shown in phantom line), which in conventional array microscopy is associated with the detector position (see FIG. 2). According to the invention, the relay system 62 images the plane 64 onto the plane 66 where the detector 42 is located. In order not to lose resolution, it is preferable that the relay system have a numerical aperture at least equal to the exit numerical aperture of the individual optical systems 38 (see FIG. 2) composing the array. Moreover, in the preferred embodiment the relay system 62 has a magnification of one (either + or −), so that the same detector 42 can be used without modification (a larger magnification could cause problems of image overlap, while a smaller magnification would require a different detector with smaller active elements in order to maintain the same degree of resolution).

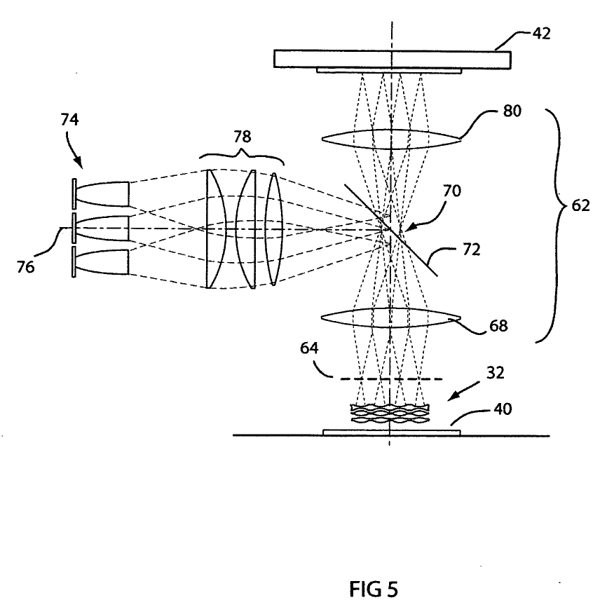

FIG. 5 illustrates a detailed embodiment of a relay system 62 according to the invention. The array microscope 32 images the object 40 onto the image plane 64, which is then imaged by the single-axis relay system 62 onto the detector 42. The array is shown as telecentric in image space (that is, the image of the array=s stop is located at infinity), which is much preferred in order to avoid problems due to the limited focusing capability of the array microscope. The stop is then imaged by a first lens 68 of the relay system 62 into the aperture stop plane 70 (referenced and illustrated by ray traces, but not otherwise shown in this figure) that preferably coincides with the position of a beam splitter 72. An illumination source 74, such as a collection of LEDs 76 with compound parabolic concentrators (CPCs) for increased light efficiency, projects light through a condenser system 78 towards the beam splitter 72. The illumination light is reflected towards the array and follows the imaging ray=s path in the opposite direction towards the object 40. The light source 74 is imaged onto the aperture stop plane 70 to produce a Koehler illumination system. The light reflected from the object 40 is collected by the array 32 and passes through the beam splitter 72 and a second lens 80 towards the detector 42. It is noted that the lenses 68 and 80 are illustrated generically in the figures, but each could consists of a more complex optical element or system especially designed to meet the requirements of a particular application.

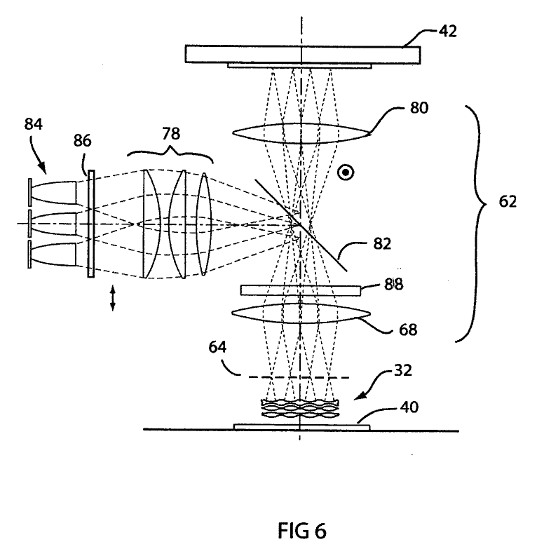

The beam splitter 72 can consist of a beam splitting cube, plate or any other element that directs at least a portion of the light energy received from the source 74 towards the object 40 and transmits at least a portion of the energy reflected from the object towards the detector 42. It is similarly possible to use polarizing elements, such as a polarizing beam splitter (PBS), to increase the efficiency of light coupling. In conventional (unpolarized) systems, the maximum attainable efficiency is 25% (calculated as a percentage of the light-source energy that reaches the detector). Using polarized light with a PBS, it is possible to increase the efficiency virtually to 100%, providing that the light source emits linearly polarized light (when the light source emits unpolarized light, the maximum efficiency is 50%). For example, as illustrated in FIG. 6, such a system could be implemented by using a polarizing beam splitter 82 and an illumination source 84 coupled with a linear polarizer 86, such that all light is reflected towards the object 40 by the PBS. A quarter-wave plate 88 inserted in the imaging train is then used to convert the linearly polarized light into circularly polarized light, which in turn undergoes a phase change upon reflection from the object 40. Thus, the returning light is polarized in the opposite direction and, when passing through the quarter-wave plate 88, it is converted into a linearly polarized light with the axis of polarization perpendicular to the original beam. Therefore, the wavefront will pass through the PBS toward the detector without losses.

Other configurations are possible, such as by using dichroic filters for epi-fluorescent imaging of tissue treated with fluorophores that attach to specific molecules or compounds. Under short-wavelength illumination (excitation), different wavelengths of light are emitted and imaged by the array. Dichroic filters can thus be used to direct the excitation light from the light source towards the object and then to let the fluorescent light through towards the detector.

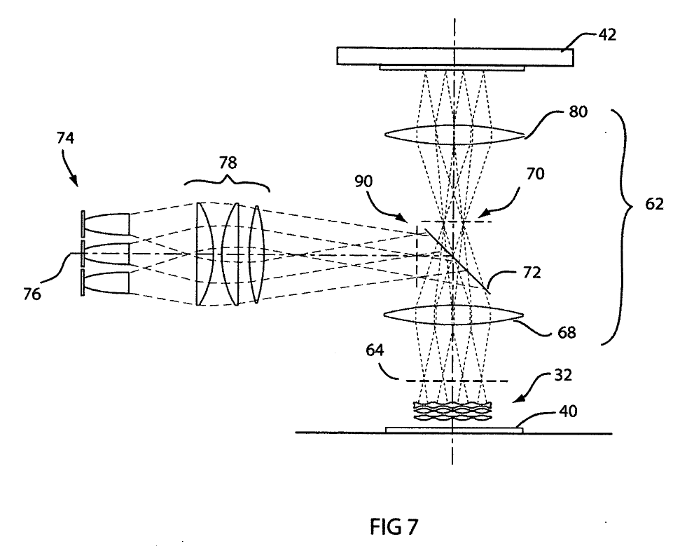

According to another aspect of the invention, the beam splitter may be located at a position other than the aperture-stop plane 70, as illustrated in FIG. 7. In such a case, the beam splitter 72 is offset in the axial direction from the pupil position and it becomes possible to separate the conjugate stop planes 90 and 70 in the illumination and imaging systems. Therefore, these plane positions can be used to place optical elements of choice to achieve particular functions. The array microscope 32 forms an image of the object 40 at plane 64, which is then relayed by the relay system 62 onto the detector 42. Conjugate images of the array's aperture stop are formed at the pupil plane 70 between the lenses 68 and 80 that constitute the relay system and at plane 90 in the illumination train. Therefore, since conjugate images of each imaging system in the array 32 are formed at these planes, all changes in amplitude or phase distribution of the illumination and/or imaging beams introduced in these planes apply equally to all systems. Thus, the planes' locations can be used advantageously to introduce changes to the illumination and imaging wavefronts, as deemed desirable for particular applications. For example, an adjustable phase plate (such as a pixellated liquid-crystal device) capable of being altered can be used (positioned at plane 70) to introduce a parabolic phase shift in the image light propagating towards the image sensor. This combination of elements would provide a means for advantageously focusing all objectives in the array microscope simultaneously.

Thus, an additional advantage of combining a multi-axis imaging system with a single-axis relay according to the invention is the easy access provided to planes conjugate with the aperture stop of the imaging system of the array microscope. This feature enables the simultaneous modification of the properties of the imaging beams from all microscopes in the array as may be required, for example, to practice phase-contrast microscopy, differential interference contrast microscopy, Nomarsky techniques, extended depth-of-field microscopy, and other procedures used in the art.

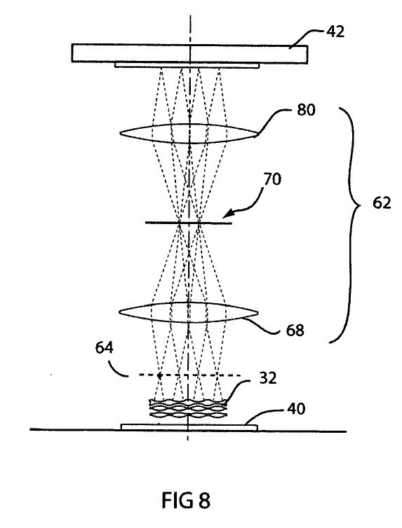

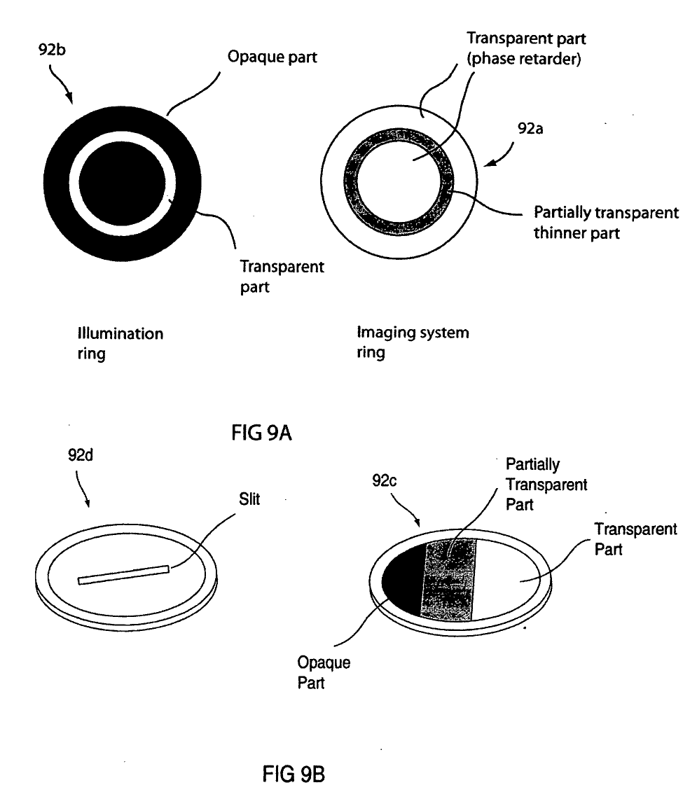

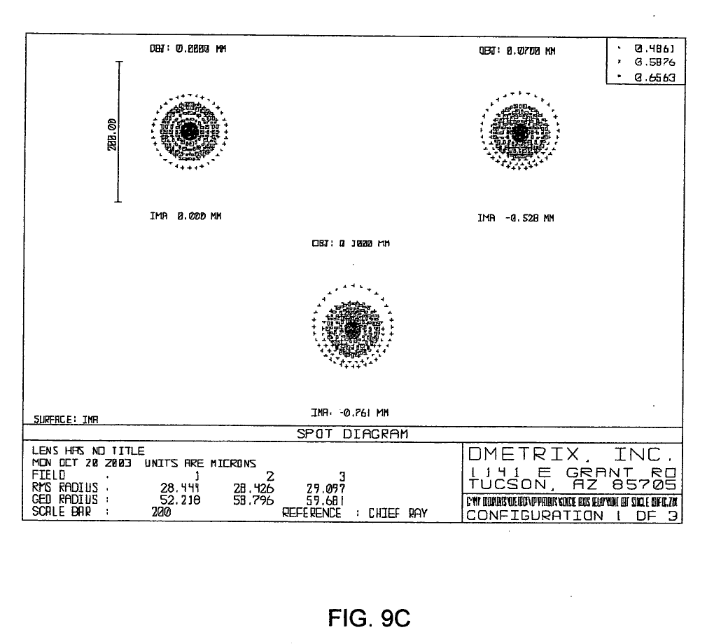

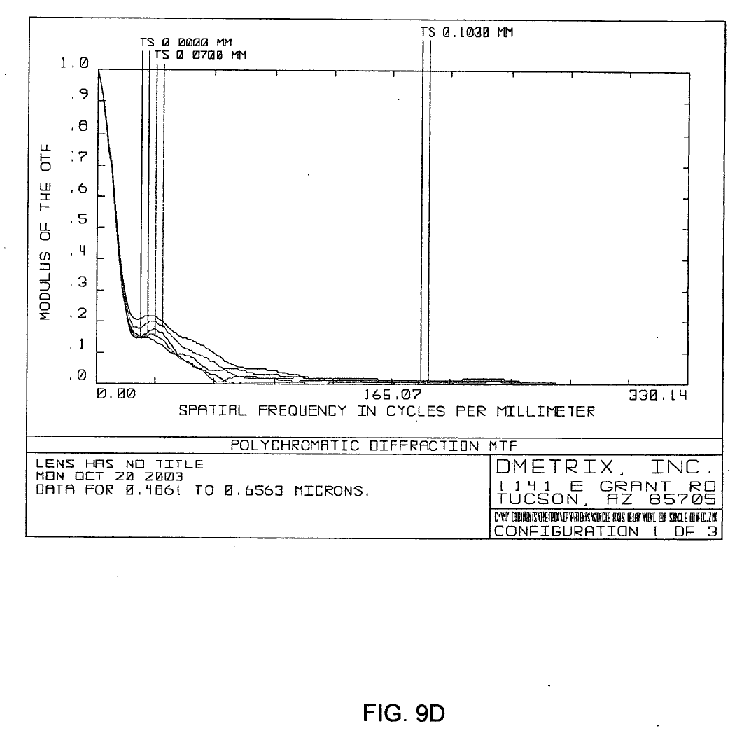

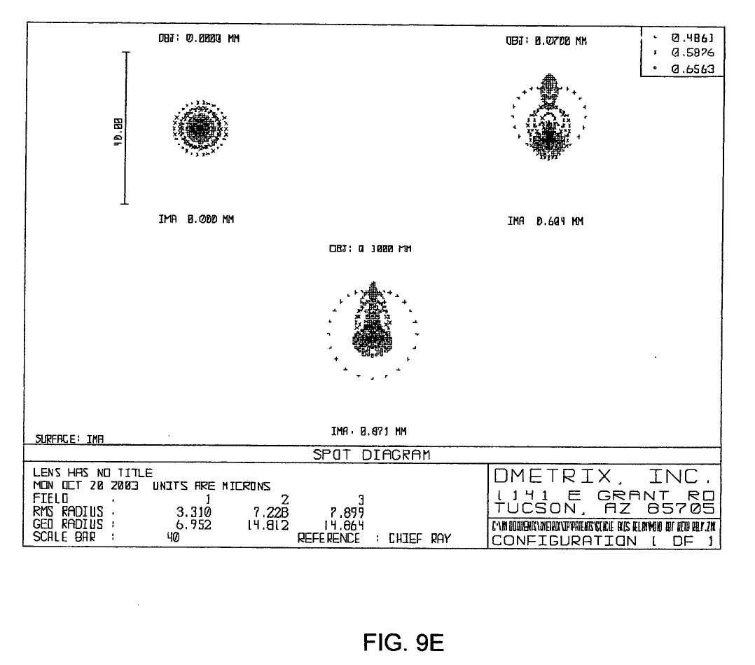

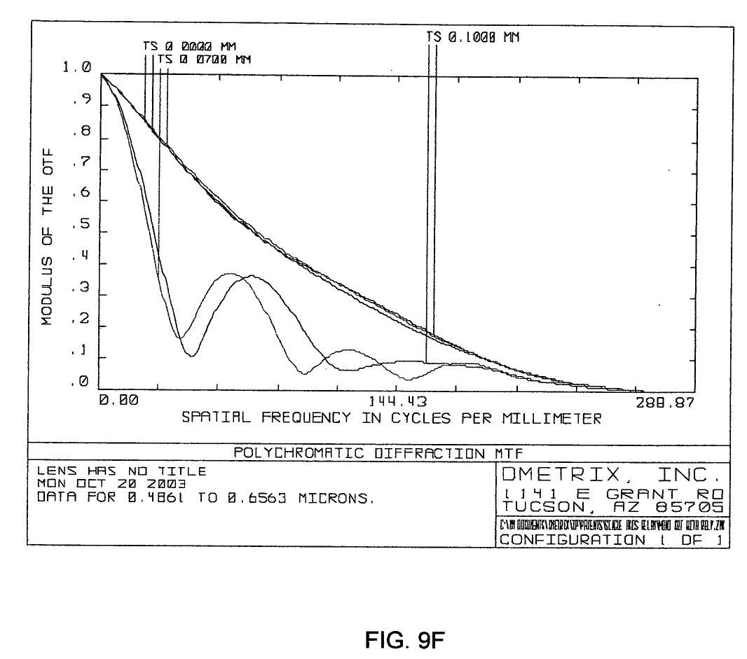

Additional examples of such adaptations are shown in FIG. 8, wherein a generic optical element 92 placed at plane 70 is used to illustrate various means for modifying the imaging beam. FIG. 9A illustrates two typical phase contrast plates 92a and 92b that can be inserted into the conjugate stop planes 70 and 90, respectively, to change the character of the light passing through. FIG. 9B illustrates two Hoffman modulation-contrast plates 92c and 92d that can be similarly inserted into the conjugate stop planes 70 and 90, respectively, for use in practicing Hoffman modulation-contrast techniques. (It is noted that these approaches are complementary to others disclosed in U.S. Ser. No. 10/191,874.)

Other examples of applications are the increase of the depth of focus by inserting a cubic phase plate (such as available from CDM Optics of Boulder, Colo., and described in U.S. Pat. No. 6,069,738); providing polarization, or differential interference contrast (DIC), as needed for Nomarsky techniques and other related techniques; and manipulating the spatial coherence of the illumination/imaging optics by introducing targeted obscurations of the pupil (i.e., in general, apodizations of the pupil). In most cases the modifying element must be matched by an appropriate element introduced in the illumination system. This can be done, for instance, using the techniques described in Ser. No. 10/191,874 or by inserting the beam splitter in a location closer to the object, hence separating the pupil location in the illumination and imaging paths. Various other potential applications and related techniques are described in M. Pluta, “Advanced Light Microscopy,” Vol. 2, Elsevier, Amsterdam, 1988.

The relay system as described can serve the additional purpose of correcting residual aberrations introduced by the microscope array objectives. The correction of aberrations is harder to achieve with materials that can be molded or otherwise manufactured into array form than with conventional optical glass, especially in the case of chromatic aberrations. Therefore, additional compensation (normally obtained by moving the detector) is often needed in array microscopy in order to image at different wavelengths. The relay system of the invention can also serve to provide such additional compensation as a matter of design of the array microscope, thereby eliminating or at least reducing the need to rely on detector motion. Being conventional in all respects, the relay system offers the advantages of conventional manufacturing technology and the ability to use a wide range of materials, such as glasses, plastics, etc., which are suitable for chromatic correction. An example of this type of design and the resulting improvements is illustrated in FIGS. 9C, 9D, 9E and 9F for three wavelengths based on the parameters listed in the table below:

Wavelengths: 3

Units: Microns

| # | Value | Weight |
|---|---|---|
| 1 | 0.486133 | 1.000000 |
| 2 | 0.587562 | 1.000000 |
| 3 | 0.656273 | 1.000000 |

Surface Data Summary:

| Surf | Type | Radius | Thickness | Glass | Diameter | Conic |
|---|---|---|---|---|---|---|
| OBJ | STANDARD | Infinity | 0.15 | BK7 | 0.2 | 0 |
| 1 | STANDARD | Infinity | 0.1396053 | | 2 | 0 |
| 2 | STANDARD | −00.8375628 | 0.9805778 | ZEONEX E48R | 0.5102225 | 0 |
| 3 | STANDARD | −0.6389631 | 0.05 | | 1.275144 | −0.181194 |
| 4 | STANDARD | 1.721522 | 2.217359 | ZEONEX E48R | 1.437748 | −2.023455 |
| STO | STANDARD | −2.282786 | 2.649335 | | 1.346608 | −0.7959226 |
| 6 | EVENASPH | 3.696897 | 0.9456149 | POLYSTYRENE | 1.107684 | 0 |
| 7 | STANDARD | 3.3896 | 0.3 | | 0.9720858 | 14.80866 |
| 8 | STANDARD | −0.7070864 | 2 | ZEONEX E48R | 0.969475 | 0 |
| 9 | STANDARD | −1.151475 | 0.9114616 | | 1.961157 | −0.5310871 |
| 10 | STANDARD | Infinity | 55.22081 | | 1.767947 | 0 |
| 11 | STANDARD | 111.6473 | 60 | LAK10 | 10.40045 | 0 |
| 12 | STANDARD | −113.1812 | 1.427063e−005 | | 13.66107 | 0 |
| 13 | STANDARD | 29.76759 | 10.83393 | SK16 | 13.66833 | 0 |
| 14 | STANDARD | 2201.738 | 3.776966 | F5 | 11.91086 | 0 |
| 15 | STANDARD | 31.07125 | 9.7031 | | 11.16835 | 0 |
| 16 | STANDARD | 31.2891 | 20 | ZEONEX E48R | 10.55819 | −0.5553795 |
| 17 | STANDARD | 165.1218 | 2 | | 7.826796 | 62.2817 |
| 18 | BINARY_2 | −24.32442 | 4 | POLYSTYRENE | 7.525433 | −0.759299 |
| 19 | STANDARD | 24.32442 | 2 | | 7.519811 | 0 |
| 20 | STANDARD | −165.1218 | 20 | ZEONEX E48R | 7.839394 | 62.2817 |
| 21 | STANDARD | −31.2891 | 8.805812 | | 10.58004 | −0.5553795 |
| 22 | STANDARD | −27.57948 | 3.776966 | F5 | 10.86448 | 0 |
| 23 | STANDARD | 631.1508 | 10.83393 | SK16 | 11.60301 | 0 |
| 24 | STANDARD | −28.33571 | 1.427063e−005 | | 13.32436 | 0 |
| 25 | STANDARD | 153.2872 | 60 | LAK10 | 13.30437 | 0 |
| 26 | STANDARD | −114.8772 | 59.01686 | | 10.3025 | 0 |
| 27 | STANDARD | Infinity | 0 | | 1.851654 | 0 |
| 28 | STANDARD | Infinity | 0 | | 1.851654 | 0 |
| IMAGE | STANDARD | Infinity | | | 1.76348 | |

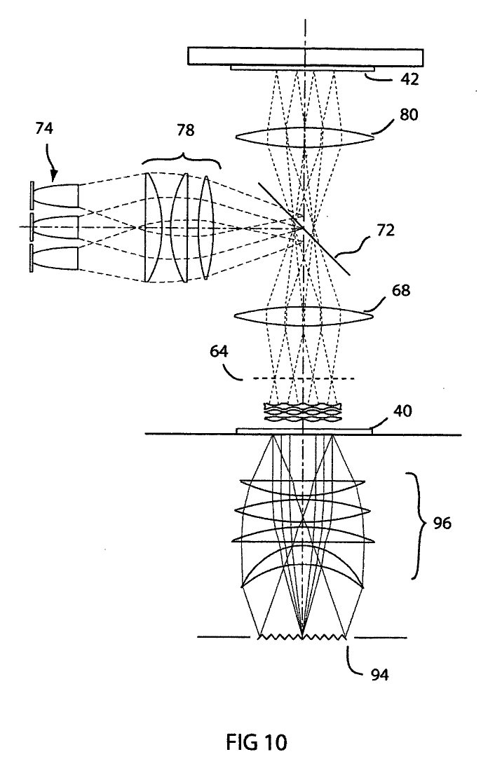

In another embodiment of the invention illustrated in FIG. 10, the system is combined with an additional light source 94 and appropriate optics 96 positioned on the side of the object 40 opposite to the imaging side in order to provide the capability of imaging in trans-illumination as well as epi-illumination modes. Obviously, each modality of observation may be practiced independently or at the same time, as needed. For example, a translucent object 40 may be observed simultaneously using epi-fluorescence and dark field trans-illumination.

As discussed above, though not essential to practice the invention, the imaging systems of the array microscope are preferably telecentric, in which case all the individual stop images of the array are coextensive. Similarly, the invention does not require that the array microscope form real images of the object that are then relayed onto the detector plane. Equivalent imaging systems can be readily designed such that the image formed by the array is virtual and a real image is projected only onto the detector. In this case it would be possible to design systems with overall negative magnification (i.e., the marginal ray does not cross the optical axis). However, the concept is more easily illustrated with relay lens and real imaging.

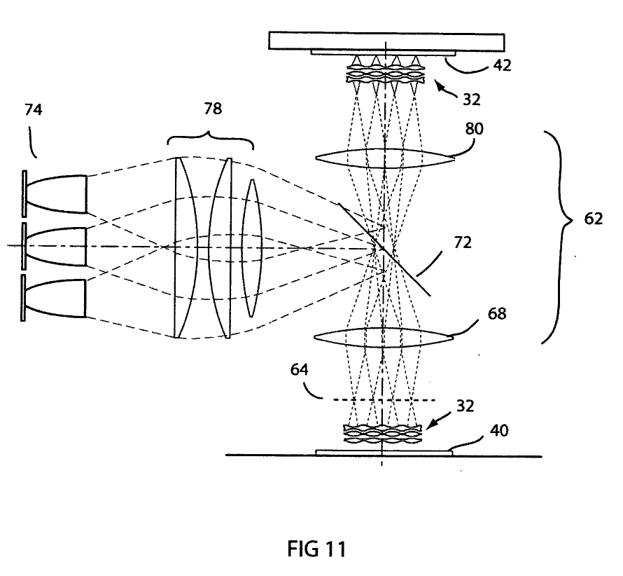

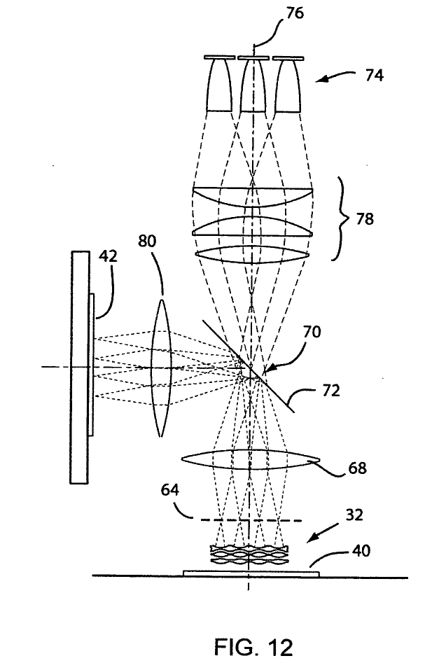

It is also noted that the invention has been illustrated using a multiple-axis imaging system followed by a single-axis relay in the imaging train, but it could as well consist of a number of differently interspersed multiple-axis and single-axis systems. For example, a single-axis relay system could be placed between two multiple-axis systems in sequence, as illustrated in FIG. 11. Similarly, the optical relay system could be used to provide side detection in epi-illumination, as illustrated in FIG. 12. In addition, various elements have been illustrated and described for modifying the illumination and/or the imaging wavefronts to perform particular procedures in the context of epi-illumination, but it is understood that the invention enables carrying out such well-known operating modalities in a most general sense, so long as a multi-axis imaging system is coupled to a single-axis relay system that produces a conjugate aperture-stop position that may be used to place optical elements in the system to affect the properties of the wavefront. Therefore, the invention lies broadly in the combination of a multi-axis imaging system with a single-axis relay system that captures the light from at least a plurality of the individual optical components in the multi-axis system.

Thus, it has been shown that the single-axis/multiple-axis system combination of the invention provides numerous advantages heretofore not available in the art. It provides space needed for implementation of epi-illumination in array microscopy. It provides access to planes conjugate with the stop plane of the array microscope, thereby permitting the implementation of various microscope modalities such as phase contrast, multi-pole illumination, differential interference contrast (DIC) microscopy, Nomarsky techniques, etc., and of other modifications aimed at improving imaging quality, such as the use of a cubic phase plate to simultaneously achieve extended depth of field for all objectives in the array microscope. The invention also allows multiple modalities of microscopy to be used simultaneously, such as epi-fluorescence and trans-illumination imaging. Finally, it also enables the correction of aberrations introduced by the array microscope.

Therefore, while the invention has been shown and described herein in what is believed to be the most practical and preferred embodiments, it is recognized that departures can be made therefrom within the scope of the invention, which is not to be limited to the disclosed details but is to be accorded the full scope of the claims including any and all equivalents thereof.

1. A multi-axis imaging device comprising:
a two-dimensional microscope array with a plurality of magnifying imaging systems disposed along a corresponding plurality of optical axes for imaging a picture of an object onto a detector, said plurality of magnifying imaging systems being arranged in rows and configured to image respective sections of the object;
a scanning mechanism for producing an imaging scan of the object as a result of a relative movement between the microscope array and the object;
an optical relay system positioned across said plurality of optical axes such that an image of said object is relayed through the relay system; and
a light source illuminating the object to produce said image and picture of the object;
wherein said imaging scan is implemented along a linear direction of scan across the object and said rows of imaging systems are staggered with respect to said direction of scan, such that each of the imaging systems acquires image data corresponding to a respective continuous strip of the object along said direction of scan during the imaging scan of the scanning mechanism.

2. The device of claim 1, wherein said optical relay system is positioned between said plurality of magnifying imaging systems and the detector.

3. The device of claim 1, wherein said plurality of magnifying imaging systems includes multiple parallel optical components, each component containing a plurality of individual optical elements corresponding to said plurality of optical axes.

4. The device of claim 3, wherein said optical relay system is positioned between a pair of said multiple parallel optical components.

5. The device of claim 1, wherein said light source illuminates the object through said optical relay system.

6. The device of claim 5, further including a second light source for trans-illumination of the object from a side opposite to said plurality of magnifying imaging systems.

7. The device of claim 2, wherein said light source illuminates the object through said optical relay systems and further including a second light source for trans-illumination of the object from a side opposite to said plurality of magnifying imaging systems.

8. The device of claim 1, further comprising a means for modifying a property of a wavefront propagated through said plurality of magnifying imaging systems.

9. The device of claim 8, wherein said wavefront is an imaging wavefront and said modifying means includes an element for modifying a phase of said imaging wavefront.

10. The device of claim 8, wherein said wavefront is an imaging wavefront and said modifying means includes an element for modifying an amplitude of said imaging wavefront.

11. The device of claim 8, wherein said wavefront is an imaging wavefront and said modifying means includes a cubic phase plate.

12. The device of claim 8, wherein said wavefront is an imaging wavefront and said modifying means includes a polarizing element.

13. The device of claim 8, wherein said wavefront is an imaging wavefront and said modifying means includes a differential interference contrast element.

14. The device of claim 8, wherein said wavefront is an imaging wavefront and said modifying means includes a means for producing targeted obscurations at a plane conjugate to an aperture stop of the device.

15. The device of claim 8, wherein said wavefront is an imaging wavefront and said modifying means includes an adjustable phase plate.

16. The device of claim 8, wherein said wavefront is an illumination wavefront received from said light source.

17. The device of claim 16, wherein said modifying means includes an element for modifying a phase of said illumination wavefront.

18. The device of claim 16, wherein said modifying means includes an element for modifying an amplitude of said illumination wavefront.

19. The device of claim 16, wherein said modifying means includes a polarizing element.

20. The device of claim 1, wherein said optical relay system includes a pair of optical elements and a beam splitter, wherein the beam splitter is adapted to reflect at least a portion of an illumination wavefront toward the object and to transmit at least portion of an imaging wavefront toward the detector.

21. The device of claim 20, wherein said beam splitter is a polarizing beam splitter and further including a linear polarizer across said illumination wavefront and a circular polarizer across said imaging wavefront.

22. The device of claim 1, wherein said optical relay system has a magnification of magnitude one.

23. The device of claim 1, wherein said plurality of imaging systems is telecentric.

24. The device of claim 1, wherein the light source is imaged into a plurality of pupils corresponding to said plurality of imaging systems.

25. A method for providing epi-illumination to a multi-axis imaging device, comprising the following steps:
providing a two-dimensional microscope array with a plurality of magnifying imaging systems disposed along a corresponding plurality of optical axes for imaging a picture of an object onto a detector, said plurality of magnifying imaging systems being arranged in rows and configured to image respective sections of the object;
providing a scanning mechanism for producing an imaging scan of the object as a result of a relative movement between the microscope array and the object;
positioning an optical relay system across said plurality of optical axes such that an image of the object is relayed through the relay system;
illuminating the object to produce said image and picture of the object; and
operating the scanning mechanism along a linear direction of scan across the object;
wherein said rows of imaging systems are staggered with respect to said direction of scan, such that each of the imaging systems acquires image data corresponding to a respective continuous strip of the object along said direction of scan during the imaging scan of the scanning mechanism.
